(19) United States
(12) Patent Application Publication
(10) Pub. No.: US 2012/0127285 A1
(43) Pub. Date: May 24, 2012

(54) SYNCHRONIZATION APPARATUS AND SYNCHRONIZATION METHOD

(75) Inventor: Takashi ISHIDOSHIRO, Nagoya-shi (JP)

(73) Assignee: Buffalo Inc., Nagoya-shi (JP)

(21) Appl. No.: 13/281,824

(22) Filed: Oct. 26, 2011

(30) Foreign Application Priority Data
Oct. 26, 2010 (JP) P2010-239991

(51) Int. Cl. H04N 15/00; G02B 27/22

(52) U.S. Cl. 348/54; 359/464; 250/206

(57) ABSTRACT

A synchronization apparatus synchronizes switchover between the right and left shutters of shutter glasses for viewing three-dimensional images, with switchover between a right-eye image frame and a left-eye image frame alternately displayed on a display device. The synchronization apparatus includes a sensor installed on the image display screen of the display device, and a controller for controlling switchover between the right and left shutters in accordance with an output signal from the sensor. The right-eye image frame and the left-eye image frame include discrimination marks for discriminating between the right-eye image frame and the left-eye image frame. The sensor detects the discrimination marks displayed on the image display screen.

### CROSS REFERENCE TO RELATED APPLICATION

This application is based upon and claims the benefit of priority from the prior Japanese Patent Application No. 2010-239991 filed on Oct. 26, 2010; the entire content of which is incorporated herein by reference.

### BACKGROUND OF INVENTION

1. Field of Invention

This invention relates to a synchronization apparatus and a synchronization method used in an active shutter three-dimensional image viewing system.

2. Description of Related Art

In recent years, attention has been paid to three-dimensional image viewing systems that allow viewers to watch three-dimensional images. One of the three-dimensional image viewing systems is called an active shutter system. The active shutter system is a system in which image frames captured at different right and left angles are displayed alternately on a display device while right and left shutters of shutter glasses are opened and closed alternately and synchronously with the image frames.

In order to implement the active shutter system, there is needed a synchronization apparatus that synchronizes switchover between right and left shutters (a right-eye shutter and a left-eye shutter) of the shutter glasses with switchover between a right-eye image frame and left-eye image frame. As the synchronization apparatus of this type is known an apparatus in which synchronizing signals are generated through processing inputted video signals and then are transmitted to a controller for shutter glasses (see Japanese Patent Application Publication No. Hei 8-322063, for example).

### SUMMARY OF THE INVENTION

Such a conventional synchronization apparatus that generates synchronizing signals from inputted video signals has the following problem. Since the generation of synchronization signals in the conventional synchronization apparatus requires the provision of an additional mechanism for causing the display device itself to output synchronizing signals or a mechanism for causing an external device (such as a tuner) to output synchronizing signals, the conventional synchronization apparatus is not applicable to the display device or the external device having none of such mechanisms.

An object of this invention is to provide a synchronization apparatus and a synchronization method which do not require a mechanism for causing a display device or an external device to output synchronizing signals.

In order to solve the problems mentioned above, this invention has the following features. According to one of the features of this invention, there is provided a synchronization apparatus for synchronizing switchover between the right and left shutters of shutter glasses (shutter glasses 20) for viewing three-dimensional images, with switchover between a right-eye image frame and a left-eye image frame alternately displayed on a display device (display device 10), comprising: a sensor (sensor 100) installed on the image display screen of the display device; and a controller (controller 200) for controlling switchover between the right and left shutters in accordance with an output signal from the sensor, wherein the right-eye image frame and/or the left-eye image frame includes a discrimination mark for discriminating between the right-eye image frame and the left-eye image frame, and the sensor detects the discrimination mark displayed on the image display screen.

According to the above-described synchronization apparatus, switchover between the right and left shutters of the shutter glasses can be synchronized with switchover between the right-eye image frame and the left-eye image frame by using the image display screen of the display device. Hence, there is provided a synchronization apparatus which does not require a mechanism for causing a display device or an external device to output synchronizing signals.

According to another feature of this invention, the discrimination mark is displayed in a location near the edge of the image display screen, and the sensor is installed in the same location as the discrimination mark on the image display screen.

According to the above-described feature, the sensor can be installed in an unnoticeable location on the image display screen.

According to another feature of this invention, the controller discriminates between the right-eye image frame and the left-eye image frame on the basis of comparing the output signal from the sensor with a threshold.

According to another feature of this invention, the sensor comprises: a photocell (photocell 101) for outputting an electrical signal corresponding to incident light; and a cover (cover 102) for covering that surface of the photocell which is opposite to the light incident surface of the photocell, and the side surfaces of the photocell.

According to the above-described feature, the sensor can be built in a simple structure, which suppresses an increase in the manufacturing cost of the synchronization apparatus. In addition, light emitted from areas other than the discrimination marks is shielded with the cover and thereby the accuracy of detecting the discrimination marks is improved.

According to another feature of this invention, the sensor further comprises an optical filter (optical filter 103) provided on the light incident surface of the photocell, and the optical filter causes only light having a specific frequency to pass through.

According to another feature of this invention, the three-dimensional image viewing system includes an external device (external device 30) for outputting a video signal including the right-eye image frame and the left-eye image frame, to the display device, and the external device inserts the discrimination mark into the right-eye image frame and/or the left-eye image frame included in the video signal.

According to the above-described feature, even when no discrimination mark is provided for the original video signals, the original video signals can be provided with discrimination marks before being inputted to the display device.

According to another feature of this invention, the three-dimensional image viewing system further includes an input device operated by a user, and the external device changes the display location and/or the size of the discrimination mark in accordance with the user's operation on the input device.

According to another feature of this invention, the external device inserts the discrimination mark in such a manner that the discrimination mark can be displayed in a non-image section included in each image frame.

According to another feature of this invention, the controller is incorporated in the shutter glasses.

According to another feature of this invention, there is provided a synchronization method for synchronizing switchover between the right and left shutters of shutter glasses for viewing three-dimensional images, with switchover between a right-eye image frame and a left-eye image frame alternately displayed on a display device, the method comprising the steps of: outputting a video signal including the right-eye image frame and the left-eye image frame to the display device, the right-eye image frame and/or the left-eye image frame including a discrimination mark for discriminating between the right-eye image frame and the left-eye image frame; detecting the discrimination mark displayed on the image display screen of the display device by a sensor installed on the image display screen; and controlling switchover between the right and left shutters by a controller in accordance with an output signal from the sensor.

### BRIEF DESCRIPTION OF DRAWINGS

FIG. 1 shows the overall structure of a three-dimensional image viewing system according to a first embodiment of this invention.

FIG. 2A describes a right-eye image discrimination mark, and FIG. 2B describes a left-eye image discrimination mark.

FIG. 3 is a schematic cross-sectional view showing the structure of a sensor according to the first embodiment.

FIG. 4 is a flowchart showing the operations of a controller and shutter glasses according to the first embodiment.

FIG. 5 is a schematic cross-sectional view showing the structure of a sensor according to the modified example of the first embodiment.

FIG. 6 shows the overall structure of a three-dimensional image viewing system according to a second embodiment of this invention.

FIG. 7 is a flowchart showing the operation of an external device according to the second embodiment.

FIG. 8 is a block diagram showing the structure of shutter glasses according to another embodiment.

### DESCRIPTION OF EMBODIMENTS

A first embodiment, a second embodiment, and other embodiments of this invention will be described with reference to the attached drawings. In all the drawings of the following embodiments, the same or similar components are labeled with the same or similar reference numerals.

### (1) First Embodiment

A first embodiment will be described below in the order of (1. 1) Structure of Three-Dimensional Image Viewing System, (1. 2) Discrimination Marks, (1. 3) Structure of Sensor, (1. 4) Operations of Controller and Shutter Glasses, (1. 5) Effect of First Embodiment, and (1. 6) Modified Example of First Embodiment.

### (1. 1) Structure of Three-Dimensional Image Viewing System

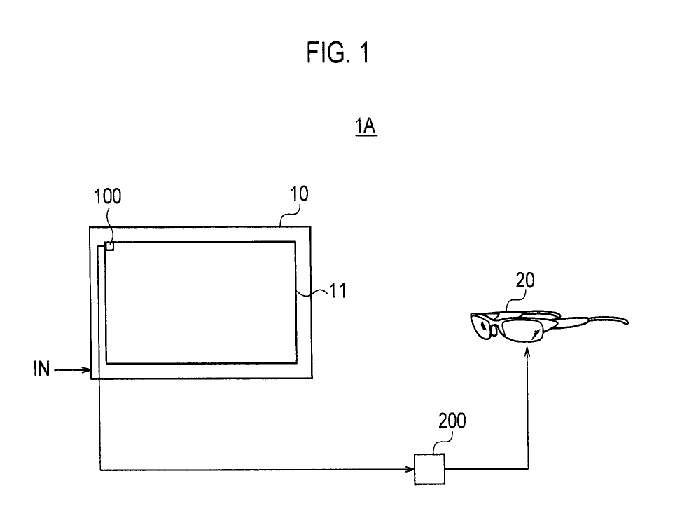

FIG. 1 shows the overall structure of a three-dimensional image viewing system 1A according to the first embodiment.

As shown in FIG. 1, the three-dimensional image viewing system 1A according to the first embodiment includes a display device 10 having an image display screen 11 for displaying three-dimensional images, a sensor 100 installed in the image display screen 11 of the display device 10, a controller 200 connected either with wire or wirelessly to the sensor 100, and shutter glasses 20 connected with wire or wirelessly to the controller 200.

In the first embodiment, the sensor 100 and the controller 200 constitute a synchronization apparatus which synchronizes switchover between the right and left shutters of the shutter glasses 20 for three-dimensional image viewing, with switchover between a right-eye image frame and a left-eye image frame alternately displayed on the display device 10.

The display device 10 is a television set or a display unit, which displays images on the image display screen 11 in response to externally supplied three-dimensional video signals IN. The three-dimensional video signals IN include a video signal IN_R for the right-eye image frame and a video signal IN_L for the left-eye image frame.

A video signal for a right-eye image discrimination mark is included in each video signal IN_R for a right-eye image frame, and a video signal for a left-eye image discrimination mark is included in each video signal IN_L for a left-eye image frame.

The display device 10 displays the right-eye image frame including the right-eye image discrimination mark and the left-eye image frame including the left-eye image discrimination mark, on the image display screen 11. Details of the right-eye image discrimination mark and the left-eye image discrimination mark will be described later.

The sensor 100 is installed on the image display screen 11. The sensor 100 detects the right-eye image discrimination mark and the left-eye image discrimination mark, and outputs a signal indicating detection result (hereinafter referred to as sensor output signal). Details of the right-eye image discrimination mark and the left-eye image discrimination mark will be described later.

The sensor output signal from the sensor 100 is inputted to the controller 200. The controller 200 discriminates between the right-eye frame and the left-eye image frame in the sensor output signal, and outputs control signals in response to the results of discrimination. Details of the controller 200 will be described later.

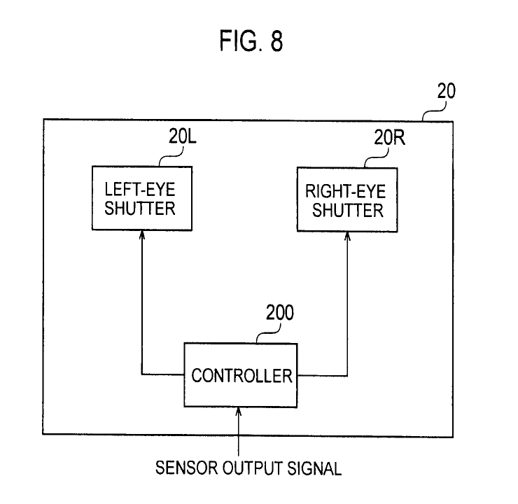

The control signals from the controller 200 are inputted to the shutter glasses 20. The shutter glasses 20 include a left-eye shutter 20L and a right-eye shutter 20R (see FIG. 8). The shutter glasses 20 open and close the left-eye shutter 20L and the right-eye shutter 20R in response to the control signals from the controller 200. Here, the left-eye shutter 20L and the right-eye shutter 20R are formed as liquid crystal shutters, for example. Details of the shutter glasses 20 will be described later.

As described above, the synchronization apparatus according to this embodiment includes the sensor 100 installed on the image display screen 11, and the controller 200 for controlling switchover between the right and left shutters (the right-eye shutter 20R and the left-eye shutter 20L) in response to the output signals from the sensor 100. The right-eye image frame and the left-eye image frame include the discrimination marks for discriminating between the right-eye image frame and the left-eye image frame. The sensor 100 detects the discrimination marks which are displayed on the image display screen 11.

### (1. 2) Discrimination Marks

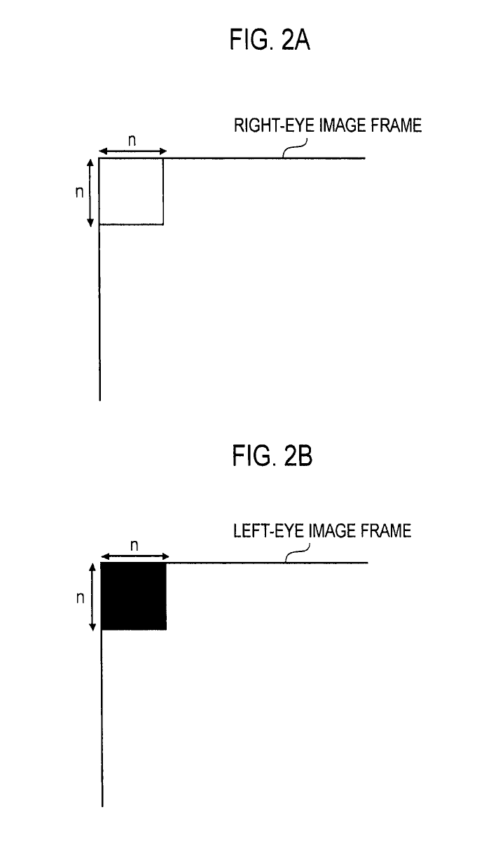

Next, details of the right-eye image discrimination mark and the left-eye image discrimination mark will be described with reference to FIGS. 2A and 2B. FIG. 2A shows the right-eye image discrimination mark, and FIG. 2B shows the left-eye image discrimination mark.

As shown in FIGS. 2A and 2B, the right-eye image discrimination mark and the left-eye image discrimination mark are displayed in locations near the edges of the image display screen 11. In the example of FIGS. 2A and 2B, the right-eye image discrimination mark and the left-eye image discrimination mark are both displayed in the top left corner of the image display screen 11.

The location to display the marks in is not limited only to the top left corner, and the marks may also be displayed in the top right corner, the bottom left corner or the bottom right corner. It is to be noted, however, that the location to display the marks in should preferably be where scan (display of the image) starts on the image display screen 11.

As shown in FIG. 2A, the right-eye image discrimination mark is represented as a white square (i.e. a high-luminance area) with n×n pixels, for example. On the other hand, as shown in FIG. 2B, the left-eye image discrimination mark is represented as a black square (i.e. a low-luminance area) with n×n pixels, for example. Alternatively, however, the right-eye image discrimination mark may be represented as a black square, and the left-eye image discrimination mark may be represented as a white square.

### (1. 3) Structure of Sensor

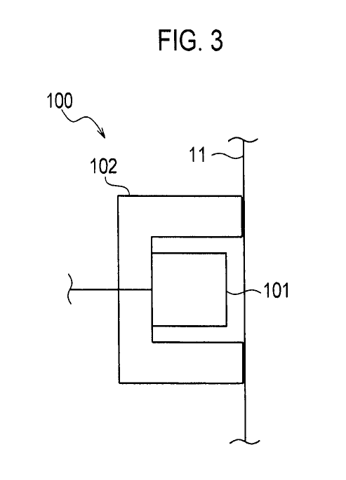

Next, the details of the sensor 100 according to the first embodiment will be described with reference to FIG. 3. FIG. 3 schematically shows in cross-section the structure of the sensor 100 according to the first embodiment. The sensor 100 is installed near the edge (at the top left corner in this embodiment) of the image display screen 11.

As shown in FIG. 3, the sensor 100 includes a photocell 101 for outputting an electrical signal in response to varying incident light intensity (i.e. the sensor output signal), and a cover 102 for covering that surface of the photocell 101 which is opposite to the light-incident surface of the photocell 101 and also covering the side surfaces of the photocell 101. The cover 102 is fixedly attached near the edge of the image display screen 11 with adhesive agent, for example. The photocell 101 may be a phototransistor, for example. A cable for transmitting the sensor output signal to the controller 200 is connected to the photocell 101.

As for the output of the photocell 100, the higher is the brightness (i.e. luminance) of the incident light, the greater is the magnitude (i.e. level) of the sensor output signal. Accordingly, when the light from the right-eye image discrimination mark represented as the white square enters the photocell 101, the sensor output signal is at a high signal level. On the other hand, in response to the light from the left-eye image discrimination mark represented as the black square, the sensor output signal is at a low signal level.

Since the photocell 101 is surrounded by the cover 102, the light from areas other than the discrimination marks is prevented from entering the light-incident surface of the photocell 101.

Here, each of the right-eye image discrimination mark and the left-eye image discrimination mark consists of n×n pixels, and the value of n can be reduced to a very small value as the sensor 100 is downsized. Accordingly, with very small image discrimination marks and therefore a very small sensor, it becomes less likely for the sensor 100 to disturb a viewer watching images.

### (1. 4) Operations of Controller and Shutter Glasses

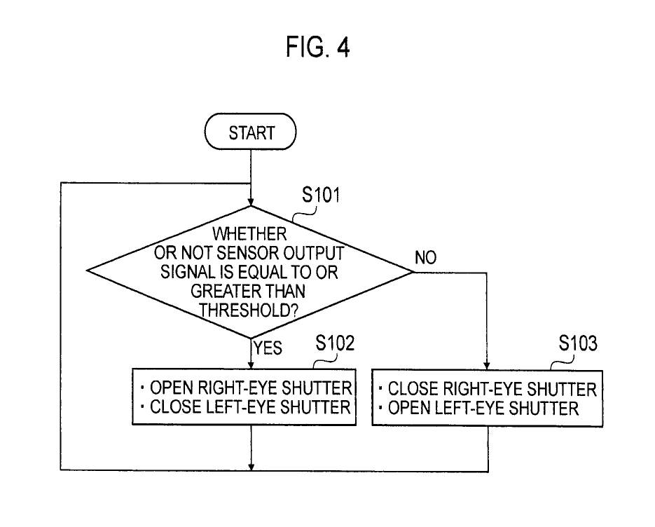

FIG. 4 is a flowchart showing the operations of the controller 200 and the shutter glasses 20, according to the first embodiment.

As shown in FIG. 4, in step S101, the controller 200 compares a sensor output signal from the sensor 100 with a threshold, and checks whether or not the sensor output signal has a value equal to or greater than the threshold. The process goes to step S102 when the value of the sensor output signal is equal to or greater than the threshold. On the other hand, the process goes to step S103 when the value of the sensor output signal is smaller than the threshold.

In step S102, the controller 200 outputs a control signal indicating the detection of the right-eye image frame, to the shutter glasses 20. Upon receiving the control signal, the shutter glasses 20 open the right-eye shutter 20R and close the left-eye shutter 20L.

In step S103, the controller 200 outputs a control signal indicating the detection of the left-eye image frame, to the shutter glasses 20. Upon receiving the control signal, the shutter glasses 20 close the right-eye shutter 20R and open the left-eye shutter 20L.

Here, the control signal outputted from the controller 200 may include two signal levels, namely, one level indicating the detection of the right-eye image frame defined as “1” and the other level indicating the detection of the left-eye image frame defined as “0”, for example.

The process returns to step S101 after step S102 or step S103.

### (1. 5) Effect of First Embodiment

As described above, according to the first embodiment, switchover between the right and left shutters of the shutter glasses 20 is synchronized with switchover between the right-eye image frame and the left-eye image frame by using the image display screen 11 of the display device 10. Hence, it is possible to provide the synchronization apparatus which does not require a mechanism for causing the display device 10 to output synchronizing signals.

Moreover, in the first embodiment, the discrimination marks are displayed in the location near the edge of the image display screen 11. The sensor 100 is installed in the corresponding position on the image display screen 11. In this way, the sensor 100 can be installed in an unnoticeable location on the image display screen 11.

Furthermore, in the first embodiment, the sensor 100 includes the photocell 101 for outputting the electrical signal in response to the intensity of the incident light, and the cover 102 for covering the surface of the photocell 101 opposed to the light-incident surface as well as the side surfaces of the photocell 101. In this way, the sensor 100 can be built in a simple structure, which can suppress an increase in the manufacturing cost of the synchronization apparatus. In addition, the light from areas other than the discrimination marks can be shielded with the cover 102 and thereby the accuracy of detecting the discrimination marks can be improved.

### (1. 6) Modified Example of First Embodiment

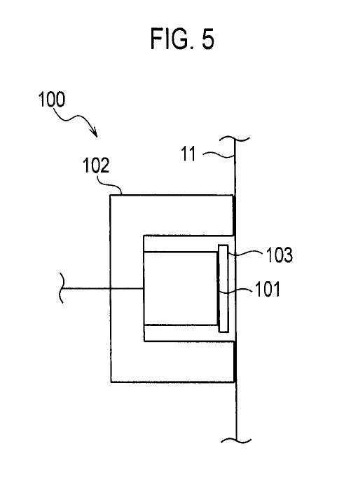

As shown in FIG. 5, in this modified example, an optical filter 103 for letting only the light having a specific frequency pass is provided on the light incident surface side of the photocell 101. According to this design, one of the right-eye image discrimination mark or the left-eye image discrimination mark may be represented as an area where the light having the specific frequency is emitted while the other mark may be represented as an area where light having a different frequency is emitted. The light having the specific frequency that passed through the optical filter 103 enters the photocell 101. The output of the photocell 101 is at the high signal level when the light having the specific frequency is incident on the photocell 101. Other features and operations are the same as those described above in conjunction with the first embodiment.

### (2) Second Embodiment

A second embodiment of this invention will be described below in the order of (2. 1) Structure of Three-Dimensional Video Viewing System, (2. 2) Operations of External Device, (2. 3) Effect of Second Embodiment, and (2. 4) Modified Example of Second Embodiment. In the second embodiment, features that are different from those in the first embodiment will be mainly described and duplicate explanations will be omitted therein.

### (2. 1) Structure of Three-Dimensional Image Viewing System

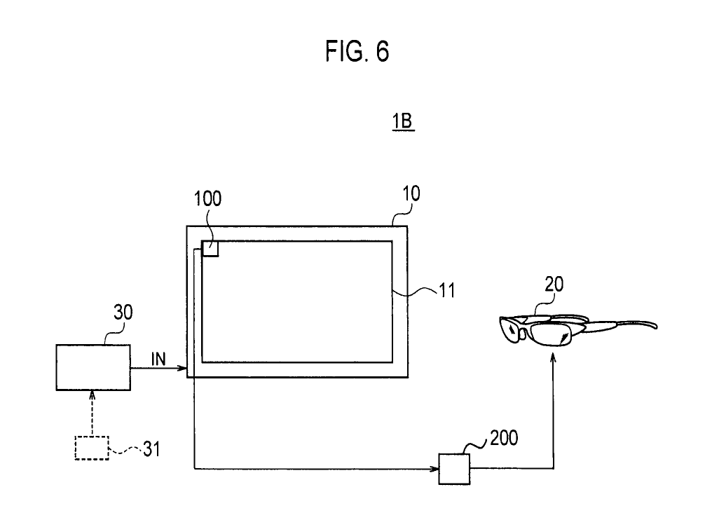

FIG. 6 shows the overall structure of a three-dimensional image viewing system according to the second embodiment.

As shown in FIG. 6, a three-dimensional image viewing system 1B according to the second embodiment is different from the first embodiment in that the three-dimensional image viewing system 1B further includes an external device 30 for outputting video signals IN to the display device 10. For example, the external device 30 may be a tuner, a disk player, or a video signal converter connected between any of these devices and the display device 10.

The external device 30 outputs the video signals IN_R and IN_L respectively generating the right-eye image frame and the left-eye image frame, to the display device 10. The external device 30 inserts, at its output stage, video signals serving as the discrimination marks into the video signals IN_R and IN_L respectively generating the right-eye image frame and the left-eye image frame. Meanwhile, the external device 30 can be operated by a remote controller 31 (input device).

In the second embodiment, the sensor 100, the controller 200, and the external device 30 constitute the synchronization apparatus which synchronizes switchover between the right and left shutters of the shutter glasses 20 for three-dimensional image viewing with switchover between the right-eye image frame and the left-eye image frame alternately displayed on the display device 10.

### (2. 2) Operation of External Device

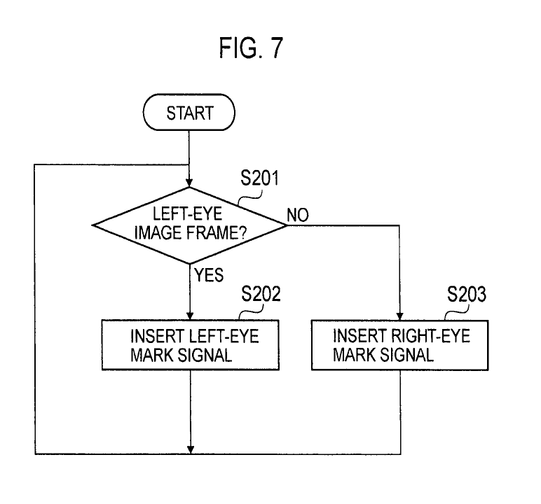

FIG. 7 is a flowchart showing the operation of the external device 30 according to the second embodiment.

As shown in FIG. 7, in step S201, the external device 30 checks whether a video signal IN to be outputted to the display device 10 is the video signal IN_L for generating the left-eye image frame or the video signal IN_R for generating the right-eye image frame. The process goes to step S202 when the video signal IN to be outputted to the display device 10 is the video signal IN_L for the left-eye image frame. On the other hand, the process goes to step S203 when the video signal IN to be outputted to the display device 10 is the video signal IN_R for the right-eye image frame.

In step S202, the external device 30 inserts the video signal for generating the left-eye image discrimination mark into the video signal IN_L for generating the left-eye image frame. To be more precise, the external device 30 replaces a video signal section for generating an edge portion of the left-eye image frame with the video signal for generating the left-eye image discrimination mark.

In step S203, the external device 30 inserts the video signal for generating the right-eye image discrimination mark into the video signal IN_R for generating the right-eye image frame. To be more precise, the external device 30 replaces a video signal section for generating an edge portion of the right-eye image frame with the video signal for generating the right-eye image discrimination mark.

Here, the left-eye image discrimination mark and the right-eye image discrimination mark can be generated in the same manner as in the first embodiment.

(2. 3) Effect of second Embodiment

As described above, according to the second embodiment, switchover between the right and left shutters of the shutter glasses 20 is synchronized with switchover between the right-eye image frame and the left-eye image frame by using the image display screen 11 of the display device 10. Hence it is possible to provide the synchronization apparatus which does not require a mechanism for causing the display device 10 or the external device 30 to output synchronizing signals.

Moreover, in the second embodiment, the external device 30 provides the discrimination marks. Accordingly, even when no discrimination mark is provided to the original video signals, the original video signals can be provided with discrimination marks before being inputted to the display device 10.

Furthermore, the second embodiment has an additional advantageous effect in comparison with the case of providing the mechanism for causing the external device 30 to output the synchronizing signals. In the case of providing the mechanism for causing the external device 30 to output the synchronizing signals, the synchronizing signals outputted from the external device 30 may be asynchronous with actually displayed images due to a process delay in the display device 10. On the other hand, the second embodiment can solve this problem because the shutter glasses 20 are synchronized with the actually displayed images.

### (2. 4) Modified Example of Second Embodiment

In the above-described second embodiment, the external device 30 inserts the right-eye image discrimination marks and the left-eye image discrimination marks of a predetermined size in a predetermined location. Alternatively, however, the external device 30 may change the display location and the size of the discrimination marks in response to an operation by a user.

When the external device 30 is so designed as to change the display location of the discrimination marks in response to an operation by a user, the sensor 100 can be installed at any location according to the user's preference. Moreover, when the external device 30 is so designed as to change the size of the discrimination marks in response to an operation by a user, the size of the sensor 100 can be fitted to the size of the discrimination marks.

Alternatively, the external device 30 may automatically change the display location and the size of any of the discrimination marks depending on the contents of the video signals IN. If an image frame includes a non-image section (such as a side panel or a letterbox), for example, the video signal for generating a discrimination mark may be inserted in such a manner that the discrimination mark can be displayed in the non-image section.

### (3) Other Embodiments

As described above, the details of this invention have been disclosed by using the embodiments of this invention.

However, it should not be understood that the description and drawings limit this invention. From this disclosure, various alternative embodiments, examples, and operation techniques will be easily thought of by those skilled in the art.

For example, in each of the embodiments described above, the control signals outputted from the controller 200 are used directly for controlling switchover between the right and left shutters. Alternatively, however, the control signals maybe used indirectly for controlling switchover between the right and left shutters. When a phase locked loop (PLL) circuit is provided in the shutter glasses 20, for example, the control signal outputted from the controller 200 may be used for resynchronization of the PLL circuit. This design reduces the risk of losing synchronization between three-dimensional images and the operations of the shutter glasses 20 even when the sensor 100 makes a false detection.

Moreover, in each of the embodiments described above, the television set or the display unit was mentioned as an example of the display device 10. But the display device 10 is not limited only to the television set or the display unit. For example, the display device 10 maybe a projector. In this case, a screen used for projecting light containing images from the projector corresponds to the image display screen.

Furthermore, in each of the embodiments described above, the controller 200 for controlling the right and left shutters is provided separately from the shutter glasses 20. Alternatively, however, it is also possible to employ the following structure. FIG. 8 is a block diagram showing the structure of a pair of shutter glasses 20 according to another embodiment. As shown in FIG. 8, the shutter glasses 20 according to the this embodiment include a controller 200 for controlling the right and left shutters (the right-eye shutter 20R and the left-eye shutter 20L) in addition to the right and left shutters (the right-eye shutter 20R and the left-eye shutter 20L). In other words, the controller 200 is provided in the shutter glasses 20 in this embodiment.

The foregoing is only a limited description of this invention made by way of embodiment, and therefore many other possible embodiments, which were not covered in the disclosure but within the scope of this invention, will naturally occur to those skilled in the art. Hence, this invention should be limited only by those claims attached to this disclosure.

What is claimed is:

1. A synchronization apparatus for synchronizing switchover between the right and left shutters of shutter glasses for viewing three-dimensional images, with switchover between a right-eye image frame and a left-eye image frame alternately displayed on a display device, comprising:
a sensor installed on the image display screen of the display device; and
a controller for controlling switchover between the right and left shutters in accordance with an output signal from the sensor, wherein
the right-eye image frame and/or the left-eye image frame includes a discrimination mark for discriminating between the right-eye image frame and the left-eye image frame, and
the sensor detects the discrimination mark displayed on the image display screen.

2. The synchronization apparatus according to claim 1, wherein
the discrimination mark is displayed in a location near the edge of the image display screen, and
the sensor is installed in the same position on the image display screen where the discrimination mark is displayed.

3. The synchronization apparatus according to claim 1, wherein
the controller discriminates between the right-eye image frame and the left-eye image frame on the basis of comparing the output signal from the sensor with a threshold.

4. The synchronization apparatus according to claim 1, wherein
the sensor comprises:
a photocell for outputting an electrical signal corresponding to incident light; and
a cover for covering that surface of the photocell that is opposite to the light incident surface of the photocell, and the side surfaces of the photocell.

5. The synchronization apparatus according to claim 1, wherein
the sensor further comprises an optical filter provided on the light incident surface of the photocell, and
the optical filter causes light having a specific frequency to pass through.

6. The synchronization apparatus according to claim 1, further comprising:
an external device for outputting a video signal including the right-eye image frame and the left-eye image frame, to the display device, wherein
the external device inserts the discrimination mark into the right-eye image frame and/or the left-eye image frame included in the video signal.

7. The synchronization apparatus according to claim 6, further comprising:
an input device operated by a user, wherein
the external device changes the display location and/or the size of the discrimination mark in accordance with the user's operation on the input device.

8. The synchronization apparatus according to claim 6, wherein
the external device inserts the discrimination mark so that the discrimination mark can be displayed in a non-image section included in each image frame.

9. The synchronization apparatus according to claim 1, wherein
the controller is incorporated in the shutter glasses.

10. A synchronization method for synchronizing switchover between the right and left shutters of shutter glasses for viewing three-dimensional images, with switchover between a right-eye image frame and a left-eye image frame alternately displayed on a display device, the method comprising the steps of:
outputting a video signal including the right-eye image frame and the left-eye image frame to the display device, the right-eye image frame and/or the left-eye image frame including a discrimination mark for discriminating between the right-eye image frame and the left-eye image frame;
detecting the discrimination mark displayed on the image display screen of the display device by a sensor installed on the image display screen; and
controlling switchover between the right and left shutters by a controller in accordance with an output signal from the sensor.
